(19) United States
(12) Patent Application Publication
(10) Pub. No.: US 2026/0261342 A1
(43) Pub. Date: Sep. 3, 2026

(54) SYSTEM FOR OPTIMIZING PROPAGATION AND DISPERSION OF AN OPTICAL SIGNAL

(71) Applicant: Hyperlume Inc., Ottawa (CA)

(72) Inventors: Ehsan Alimohammadian, Ottawa (CA); Hossein Fariborzi, Auburndale, MA (US); Mohsen Asad, Ottawa (CA)

(73) Assignee: Hyperlume Inc., Ottawa, ON (CA)

(21) Appl. No.: 19/067,266

(22) Filed: Feb. 28, 2025

(51) Int. Cl. H04B 10/2513; G02B 6/42

(52) U.S. Cl. CPC H04B 10/2513; G02B 6/4206

(57) ABSTRACT

Disclosed is a system for optimizing propagation and dispersion of an optical signal. A micro-light emitting diode (LED) source emits an optical signal with a predefined divergence angle. An optical coupling element modifies micro-LED source's predefined divergence angle to control propagation of the emitted optical signal. An optical fiber comprises a core having a predefined numerical aperture and a diameter, wherein the core receives the modified optical signal at an input end, induces minimal or near zero dispersion to the received optical signal, thereby facilitating high bandwidth transmission of the optical signal at an output end. An interface disposed at between the coupling element and the input end reduces optical loss. A detector disposed at the output end of the optical fiber receives the dispersion-compensated optical signal.

### TECHNICAL FIELD

The present disclosure generally relates to optical signal transmission systems. Further, the present disclosure particularly relates to an optical fiber-based system for optimizing propagation and dispersion of an optical signal emitted by a micro-light emitting diode source.

### BACKGROUND

Generally, micro-light emitting diodes (micro-LEDs) with high modulation bandwidth and energy efficiency have facilitated advancements in short optical links. Optical fiber communication links operating in the visible wavelength range and incorporating micro-LEDs have been utilized for short-distance transmission ranging from 1 m to 10 m. Optical fibers transmitting micro-LED-generated optical signals have been used for chip-to-chip connections, high-speed data transfer applications, and other short-range optical communication networks. The increasing demand for low-latency, high-bandwidth optical links in applications such as interconnects in computing systems, augmented reality displays, and sensor networks has led to the adoption of micro-LEDs as optical sources.

Moreover, short-distance optical links employing micro-LEDs encounter bandwidth limitations due to the broad spectral width of micro-LEDs in comparison to lasers. The wide spectral width introduces chromatic dispersion, which reduces the effective bandwidth of the modulated optical signal transmitted through an optical fiber. Chromatic dispersion occurs because different wavelengths within the broad emission spectrum of a micro-LED travel at different speeds through the optical fiber. The variation in propagation velocities leads to pulse broadening, which limits the maximum achievable data rate and increases signal distortion. As a result, chromatic dispersion restricts the maximum bandwidth of fiber for a given fiber length, thereby constraining the performance of micro-LED-based optical transmission systems. The severity of chromatic dispersion depends on factors the LED spectral width, the refractive index of the fiber core material, and the operating wavelength range.

Further, optical system designs conventionally utilize fibers with minimum chromatic dispersion in the infrared wavelength range. Such fibers have been optimized for optical links using laser sources, which possess small spectral widths and minimal wavelength-dependent propagation delays. The use of such fibers in LED-based short-distance optical links operating in the visible wavelength range imposes bandwidth limitations, even when the propagation loss of the fiber remains within acceptable limits. The spectral characteristics of micro-LED sources necessitate alternative fiber designs to mitigate chromatic dispersion while maintaining efficient optical transmission. The selection of fiber parameters, including core diameter, numerical aperture, and refractive index profile, manages dispersions (modal and chromatic) while optimizing coupling efficiency and optical power transmission.

Additionally, other optical fiber-based transmission techniques have been employed to address chromatic dispersion in short-distance optical communication. Such techniques comprise dispersion-compensating fibers, spectral filtering approaches, and electronic equalization schemes. Dispersion-compensating fibers introduce additional complexity in fabrication and integration with micro-LED-based systems, as they require specific refractive index profiles or additional fiber segments with opposite dispersion characteristics. Spectral filtering techniques selectively limit portions of the emitted optical spectrum to reduce the effects of chromatic dispersion; however, such approaches reduce the overall optical power available for transmission, thereby affecting system efficiency. Electronic equalization schemes involve signal processing techniques to compensate for dispersion-induced distortions, but such methods increase system complexity, processing delays, and power consumption. Each of such approaches introduces trade-offs in optical signal integrity, implementation feasibility, and overall transmission performance.

In light of the above discussion, there exists an urgent need for solutions that overcome the problems associated with conventional systems and techniques for optical fiber-based transmission in short-distance communication links.

### SUMMARY

In an aspect, the present disclosure comprises a system for optimizing propagation and dispersion of an optical signal. A micro-light emitting diode (LED) source emits an optical signal with a predefined divergence angle. A coupling element optically coupled to the micro-LED source modifies the predefined divergence angle to control propagation of the emitted optical signal. An optical fiber comprises a core and cladding having a predefined numerical aperture and a diameter, wherein the core receives the modified optical signal at an input end, optimizes dispersion of the received optical signal, and facilitates emission of a dispersion-compensated optical signal at an output end. An interface disposed between the coupling element and the input end increasing the coupling efficiency and light extraction. A detector disposed at the output end of the optical fiber receives the dispersion-compensated optical signal.

In another aspect, the coupling element comprises a micro-lens assembly that modifies the predefined divergence angle of the emitted optical signal. The micro-lens assembly changes the emission profile of the optical signal, reducing divergence and improving coupling efficiency of the optical fiber. The micro-lens assembly facilitates optical power transfer by focusing or collimating the emitted optical signal, reducing signal losses at the fiber input. The micro-lens assembly improves coupling efficiency, providing a stable optical signal for transmission through the optical fiber.

In yet another aspect, the coupling element comprises a diffractive optical unit that modifies at least one phase characteristic of the emitted optical signal. The diffractive optical unit influences the wavefront properties of the optical signal, adjusting phase variations and controlling the divergence pattern of the emitted optical signal. The diffractive optical unit enables beam shaping, directing more optical power into the optical fiber. The diffractive optical unit mitigates phase distortions, improving signal quality and reducing propagation errors in short-distance optical links.

In yet another aspect, the core is associated with a graded-index profile that regulates a modal dispersion of the dispersion-compensated optical signal. The graded-index profile provides a continuous refractive index variation within the core, reducing intermodal dispersion and improving optical signal transmission. The graded-index profile maintains uniform light propagation across different modes, minimizing pulse broadening and increasing bandwidth efficiency. The graded-index profile enhances coupling performance by maintaining stable light propagation over short transmission distances, optimizing optical signal integrity.

In an aspect, the present disclosure provides a core of an optical fiber fabricated from a material selected from a fluorinated polymer, polymethyl methacrylate (PMMA), or silica-based glass to reduce chromatic dispersion of a dispersion-compensated optical signal. Further, said material selection influences refractive index properties, minimizing wavelength-dependent dispersion effects and improving optical signal transmission.

In another aspect, the interface comprises a refractive index-matching material layer disposed between the coupling element and the input end of the optical fiber. The refractive index-matching material layer minimizes optical reflection at the interface, reducing signal losses and improving overall transmission efficiency. The refractive index-matching material layer facilitates optical coupling between the coupling element and the fiber, mitigating unwanted back reflections that could degrade signal quality. The refractive index-matching material layer provides compatibility between optical components, facilitating stable and reliable signal propagation.

In yet another aspect, the detector comprises a light conversion unit disposed at the output end of the optical fiber, wherein the light conversion unit converts the received dispersion-compensated optical signal into an electrical signal. The light conversion unit processes the transmitted optical signal, providing accurate signal conversion for subsequent electronic analysis. The light conversion unit improves signal fidelity by reducing noise and distortion during optical-to-electrical conversion. The light conversion unit provides stable and high-speed signal detection for short-distance optical communication.

In another aspect, the optical fiber comprises a predefined numerical aperture ranging from 0.17 to 0.7. The numerical aperture defines the acceptance angle of the optical fiber, influencing light collection efficiency and transmission characteristics. The numerical aperture selection optimizes coupling efficiency while balancing modal dispersion constraints, providing high-quality light propagation through the fiber. The numerical aperture provides compatibility with various optical sources and detectors, allowing integration into different optical transmission systems.

In another aspect, the optical fiber is separated from the micro-LED source by a first distance and is separated from the coupling element by a second distance. The first distance and the second distance influence optical signal coupling efficiency and alignment with transmission components. The spatial arrangement of the optical fiber with respect to the micro-LED source and the coupling element controls optical power transfer while minimizing insertion losses. The defined spacing provides optical alignment stability, improving overall transmission performance.

According to an aspect, a positioning assembly controls the first distance and the second distance to regulate an optical power coupling efficiency between the optical fiber and the micro-LED source. The positioning assembly provides spatial alignment of optical components, providing optimal coupling conditions for improved transmission efficiency. The positioning assembly maintains optical power transfer by dynamically adjusting alignment in response to mechanical tolerances and environmental variations. The positioning assembly supports automated or manual adjustments to provide optical system flexibility and integration.

In another aspect, the core comprises a photonic crystal structure that modifies chromatic dispersion properties at an operational wavelength. The photonic crystal structure provides wavelength-dependent light confinement, providing dispersion control in short-distance optical transmission. The photonic crystal structure provides spectral filtering capabilities, reducing transmission impairments due to chromatic dispersion. The photonic crystal structure improves waveguide performance, providing signal propagation with minimal spectral distortion.

In another aspect, the detector is configured with an adaptive noise filter that filters unwanted optical interference in the dispersion-compensated optical signal. The adaptive noise filter selectively attenuates noise components, providing signal clarity and detection accuracy. The adaptive noise filter compensates for environmental noise variations, providing optical signal reception. The adaptive noise filter provides signal-to-noise ratio, facilitating high-speed and low-distortion optical communication.

In another aspect, the diameter of the core of the optical fiber is adjusted within a range of 2 μm to 400 μm. The core diameter influences modal dispersion, confinement efficiency, and optical signal propagation characteristics, allowing optimization of optical transmission performance based on application requirements.

In another aspect, a method for optimizing propagation and dispersion of an optical signal comprises emitting an optical signal from a micro-LED source with a predefined divergence angle. A coupling element modifies the predefined divergence angle of the micro-LED source to control the propagation of the emitted optical signal. The coupling element increases the efficiency of the optical power coupling to the optical fiber. The modified optical signal is received at an input end of an optical fiber, wherein a core of the optical fiber has a predefined numerical aperture and a diameter. The core optimizes dispersion of the received optical signal and facilitates emission of a dispersion-compensated optical signal at an output end of the optical fiber. An interface disposed between the coupling element and the input end reduces optical reflection, improving optical signal transmission. The dispersion-compensated optical signal is detected using a detector positioned at the output end of the optical fiber, wherein the detector analyzes the received signal quality.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams.

FIGS. 1A-1B illustrate prior art related to optimizing the propagation and dispersion of optical signals in active optical cables, in accordance with embodiments of the present disclosure;

FIGS. 2A-2C illustrate prior art related to optimizing the propagation and dispersion of optical signals in active optical cables, in accordance with embodiments of the present disclosure;

FIG. 3 illustrates a system 300 to optimize propagation and dispersion of an optical signal, in accordance with various implementations of the present disclosure;

FIG. 4 illustrates a method 400 for optimizing propagation and dispersion of an optical signal in accordance with embodiments of the present disclosure;

FIG. 5 illustrates a design chart for a short-distance micro-LED, in accordance with embodiments of the present disclosure;

FIG. 6 illustrates a graphical representation of minimizing the chromatic dispersion coefficient for a short-distance link ranging from 1m to 10m operating in a visible wavelength, in accordance with embodiments of the present disclosure;

FIG. 7 illustrates a comparison between the dispersion coefficient of silicon oxide, PMMA, and a fluorinated polymer over a wavelength range of 400 to 1600 nm, in accordance with embodiments of the present disclosure; and

FIG. 8 shows a table of theoretical values for model dispersion, chromatic dispersion, and total dispersion for fiber lengths of 1 m, 3 m, and 10 m, calculated for various examples of fibers commercially available for imaging and communication applications, in accordance with embodiments of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

As used herein, the term “system” refers to an arrangement of components that interact to facilitate a defined operation. Such system comprises one or more electronic, optical, or mechanical components that function collectively to achieve a particular purpose. The components of such system comprise, but are not limited to, processing units, sensing elements, transmission components, structural elements, and control units. Said system is used across multiple fields including telecommunications, medical diagnostics, industrial automation, and data transmission. The operation of such system is dependent on the coordination of various interconnected components, each performing a specific role. A system for optical communication incorporates a source for emitting an optical signal, transmission components such as waveguides or fibers, and a receiving unit for detecting the transmitted optical signal. Such system is used in high-speed data transmission applications, where signal integrity and dispersion control are significant considerations. Fiber optic communication networks, optical sensors for industrial monitoring, and biomedical imaging systems utilizing light-based diagnostics are examples of such system.

As used herein, the term “micro-light emitting diode (LED) source” refers to a light-emitting component that produces optical radiation through electroluminescence. Such micro-LED source comprises a semiconductor arrangement that generates optical emission when subjected to an electric current. The emission characteristics of such micro-LED source depend on factors including material composition, doping profile, and electrical input parameters. The wavelength of the emitted optical radiation is determined by the bandgap energy of the semiconductor material. Such micro-LED source is integrated into optical communication systems, display technologies, biomedical imaging devices, and illumination systems. The dimensions of such micro-LED source are significantly smaller than conventional light-emitting diodes, enabling compact integration into various applications. Gallium nitride-based emitters for visible light applications, indium phosphide-based emitters for infrared communication, and organic light-emitting diode sources used in flexible electronic displays are comprised within such micro-LED source.

As used herein, the term “emitting” refers to the process of generating and radiating optical energy from a source. Such emitting occurs when an electrical or photonic stimulus triggers the release of photons from a material. The characteristics of such emitting depend on the excitation mechanism, material properties, and environmental conditions. Emitting is a fundamental process in optical transmission, where light sources generate optical signals for data communication, sensing, or illumination. Semiconductor electroluminescence in micro-LED sources, spontaneous and stimulated emission in laser systems, and fluorescence in organic or phosphorescent materials are different forms of such emitting.

As used herein, the term “optical signal” refers to an electromagnetic wave within a defined wavelength range that carries information through optical transmission. Such optical signal is characterized by properties including wavelength, intensity, etc. The modulation of such optical signal is performed to encode data for transmission over optical communication channels. The propagation characteristics of such optical signal depend on the transmission medium, which comprises optical fibers, free-space channels, and integrated photonic waveguides. Laser-generated signals used in fiber optic communication and modulated visible light signals in photonic computing applications are examples of such optical signal.

As used herein, the term “predefined divergence angle” refers to a specific angular spread at which an emitted optical signal propagates from a source. Such predefined divergence angle is determined by factors including the optical source design, emission aperture, and refractive properties of the surrounding medium. The magnitude of such predefined divergence angle influences coupling efficiency with optical transmission components such as lenses, fibers, and waveguides. Controlling such predefined divergence angle is important for directing light propagation and minimizing optical losses. Collimated emission from laser diodes, Lambertian emission from micro-LED sources, and highly divergent emission from organic light-emitting diode sources used in display technologies exhibit different variations of such predefined divergence angle.

As used herein, the term “coupling element” refers to a component that facilitates the transfer of optical energy between an emitting source and a receiving medium. Such coupling element modifies the propagation characteristics of an optical signal to improve amount of light coupled into a transmission medium. Such coupling element comprises, but is not limited to, lenses, diffraction gratings, prisms and waveguides. The function of such coupling element is to adjust beam divergence, refocus optical energy, or redistribute intensity profiles to enhance optical transmission. Micro-lens arrays, fiber couplers for mode-matching, and diffractive optical elements for wavefront shaping are examples of such coupling element.

As used herein, the term “modifying” refers to the process of altering one or more properties of an optical signal. Such modifying comprises changes to divergence, phase, amplitude, intensity, or polarization characteristics of the optical signal. The modification of such optical signal is achieved using optical components such as lenses, diffraction elements, modulators, and waveguides. The purpose of such modifying is to optimize signal transmission, improve coupling efficiency, or enable desired optical interactions.

As used herein, the term “optically coupled” refers to the physical or functional interaction between two optical components that enable energy transfer. Such optically coupled components facilitate the transmission of optical signals without significant losses or distortions. The nature of such optically coupled connection depends on factors including optical alignment, refractive index matching, and mode-matching conditions. Direct fiber-to-fiber splicing, free-space optical alignment using precision mounts, and evanescent field coupling between waveguides in photonic circuits are examples of such optically coupled configurations.

As used herein, the term “transmission medium” refers to the material that facilitates the propagation of an optical signal. Such transmission medium comprises optical fibers, planar waveguides, free-space channels, and photonic integrated circuits. The characteristics of such transmission medium, including refractive index, dispersion properties, and attenuation coefficients, influence the performance of optical signal propagation. Silica-based optical fibers for long-haul communication, polymer optical waveguides for flexible photonic interconnects, and semiconductor waveguides in silicon photonics applications are variations of such transmission medium.

As used herein, the term “detector” refers to a component that receives and processes an optical signal to extract information. Such detector comprises materials capable of converting optical energy into electrical signals or other measurable quantities. The performance of such detector depends on factors including sensitivity, response time, spectral range, and noise characteristics. Photodiodes for high-speed optical communication, avalanche photodetectors for low-light sensing, and charge-coupled device arrays used in imaging applications fall within such detector.

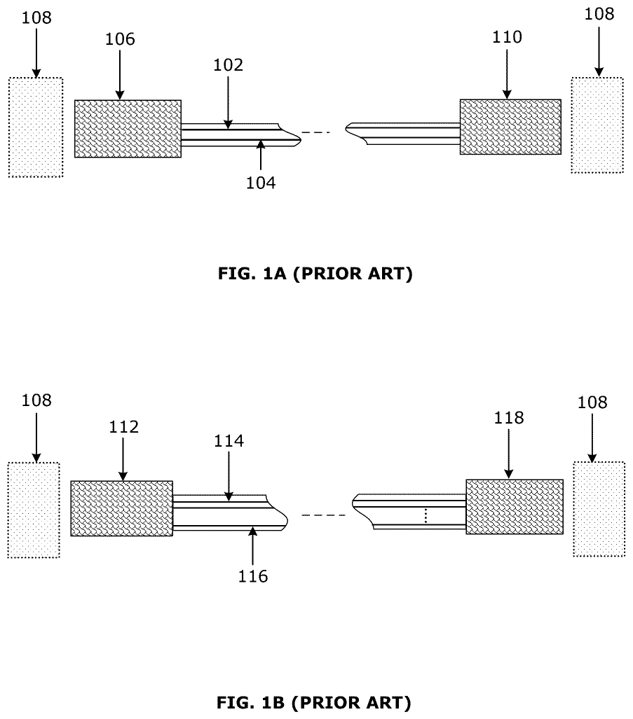

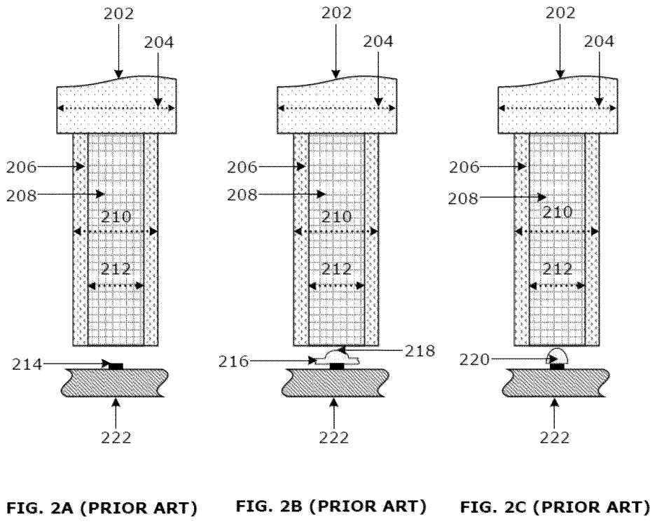

FIGS. 1A-1B, and FIGS. 2A-2C illustrate prior art related to optimizing the propagation and dispersion of optical signals in active optical cables, in accordance with embodiments of the present disclosure. FIG. 1A depicts a first type of active optical cable comprising a single send fiber 112 and a single receive fiber 114, with a link that comprises micro-LEDs, photodiodes, and associated electronics 112. Said configuration offers simplicity and cost-effectiveness; however, said configuration suffers from limited data transmission capacity due to a single send and receive channel, making said configuration less suitable for high-speed and high-bandwidth applications. FIG. 1B shows a second type of optical cable that consists of two fiber bundles, one for transmission 114 and one for reception 116, or a single fiber bundle containing multiple fibers, where specific fibers are designated for sending and others for receiving data. Said fiber bundles may be fabricated using small fibers glued together or arranged within an alignment plate made of glass or other materials featuring holes or tapered holes. Said approach enables higher data throughput but increases complexity, cost, and alignment challenges. Additionally, signal loss due to fiber misalignment remains a significant concern. Both types of optical links can interface with additional electronics, such as chips and circuit boards 108.

FIGS. 2A-2C further illustrates how individual optical fibers or individual fibers in bundles are positioned in relation to the micro-LED 214 mounted on a substrate 222. In one embodiment, micro-LEDs may be placed directly in front of optical fibers without lenses or other optical components, as shown in FIG. 2A, simplifying manufacturing but resulting in lower coupling efficiency and signal loss. Alternatively, a micro-lens 218 affixed to a thin layer 216 can be integrated onto the substrate 222 with the micro-LEDs, as shown in FIG. 2B. Said arrangement improves coupling efficiency but adds fabrication complexity and requires alignment. A micro-lens array (MLA) may be placed over an array of micro-LEDs. Another embodiment comprises a coupling or focusing optical element 220 positioned on the micro-LEDs, as shown in FIG. 2C, which can be fabricated using two-photon or multi-photon polymerization methods. Said arrangement improves power extraction and coupling efficiency but introduces fabrication challenges and cost constraints. The space between micro-LEDs and fiber tips, as shown in FIG. 2A, or between coupling optics and fiber tips, as shown in FIG. 2B and FIG. 2C, can be filled with refractive index matching materials or light-guiding optical elements to reduce losses. Optical fibers feature protective layers 202, cladding 206, and cores 208, with design parameters such as protective layer diameter 204, cladding diameter 210, and core diameter 212 influencing power collection and modal dispersion. The numerical aperture (NA) of the fiber, controlled by the refractive index of the core and cladding, determines the amount of coupled light and modal dispersion. Optimization of micro-LED size, fiber spacing, and optical coupling element maximizes the delivered power for a certain fiber length. Challenges related to signal dispersion, fabrication complexity, and alignment precision remain key limitations in both prior arts.

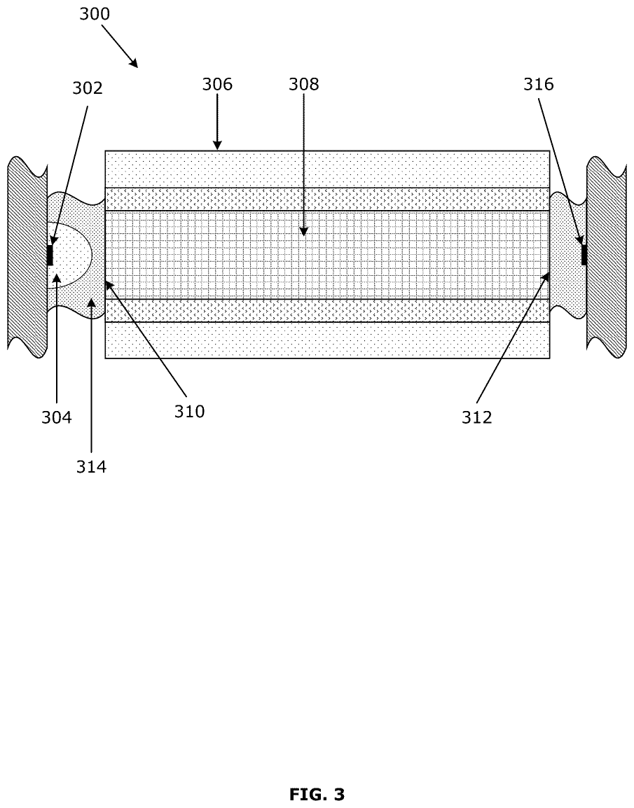

FIG. 3 illustrates a system 300 to optimize propagation and dispersion of an optical signal, in accordance with embodiments of the present disclosure. The system 300 comprises a micro-LED (LED) source 302 that emits an optical signal with a predefined divergence angle. The micro-LED source 302 comprises a semiconductor-based light-emitting component that generates optical radiation in response to an applied electrical input. The emission wavelength of the optical signal corresponds to the bandgap energy of the semiconductor material forming the micro-LED source 302. The emission characteristics are influenced by factors such as doping concentration, current density, and device geometry. The predefined divergence angle is determined by the emission aperture, surface structure, and refractive index contrast between the semiconductor material and the surrounding medium. The micro-LED source 302 produces optical radiation within a spectral range that is dependent on the composition of the semiconductor layers. The optical signal emitted by the micro-LED source 302 propagates outward with an angular distribution that affects coupling efficiency with downstream optical components. The emission pattern may be influenced by surface coatings, micro-cavity structures, or refractive index-matched encapsulants applied to the micro-LED source 302. The micro-LED source 302 is fabricated using epitaxial growth techniques, photolithographic patterning, and etching processes that define the emission characteristics. The emitted optical signal undergoes angular divergence based on the internal and external optical interfaces of the micro-LED source 302. The divergence of the optical signal is influenced by internal reflection effects, photon escape probability, and device packaging design. The emitted optical signal serves as an input to subsequent optical transmission components that control propagation characteristics and dispersion properties. The predefined divergence angle determines how the optical signal interacts with downstream coupling and transmission elements. The micro-LED source 302 operates within an electrical drive configuration that supplies a controlled current and voltage input to regulate optical emission parameters.

In an embodiment, the system 300 further comprises a coupling element 304 optically coupled to the micro-LED source 302, wherein the coupling element 304 modifies the predefined divergence angle to control propagation of the emitted optical signal. The coupling element 304 is positioned in proximity to the emission aperture of the micro-LED source 302 to receive the optical signal and influence propagation characteristics. The coupling element 304 comprises an optical structure that alters the divergence of the emitted optical signal by refraction, diffraction, or reflection. The coupling element 304 comprises one or more optical components such as micro-lenses, graded-index structures, diffractive elements, or reflective surfaces. The interaction between the optical signal and the coupling element 304 modifies the emission profile, directing the optical signal toward a defined propagation path. The coupling element 304 adjusts the angular distribution of the emitted optical signal by converging, collimating, or diffusing the optical radiation. The positioning of the coupling element 304 is determined based on the emission properties of the micro-LED source 302 and the intended optical path. The material composition of the coupling element 304 affects optical transmission efficiency, refractive index matching, and dispersion characteristics. The coupling element 304 is fabricated using transparent optical materials such as silica, polymers, etc. that exhibit defined refractive index properties. The optical properties of the coupling element 304 influence the phase, amplitude, and intensity distribution of the transmitted optical signal. The coupling element 304 is integrated as a separate optical component or as a surface-structured feature applied to the emission interface of the micro-LED source 302. The coupling element 304 is positioned and aligned to optimize optical signal transfer while minimizing losses.

In an embodiment, the system 300 further comprises an optical fiber 306 comprising a core 308 having a predefined numerical aperture and a diameter, wherein the core 308 receives the modified emitted optical signal at an input end 310, wherein the core 308 optimizes dispersion of the received optical signal and facilitates the emission of a dispersion-compensated optical signal at an output end 312. The optical fiber 306 serves as a transmission medium for guiding the modified optical signal along a defined path while controlling dispersion effects. The core 308 of the optical fiber 306 is formed from a material with a controlled refractive index profile that influences optical signal confinement and propagation. The numerical aperture of the core 308 determines the acceptance angle of the optical signal entering the optical fiber 306 at the input end 310. The diameter of the core 308 influences mode propagation characteristics and coupling efficiency with the modified emitted optical signal. The optical fiber 306 is fabricated using materials such as silica, fluorinated polymers, or other optically transparent substances with specific dispersion properties. The optical fiber 306 comprises a cladding layer surrounding the core 308, wherein the cladding has a lower refractive index than the core 308 to facilitate total internal reflection. The propagation of the optical signal through the core 308 is influenced by the refractive index gradient, fiber length, and mode propagation conditions. The optical fiber 306 may be a single-mode or multimode depending on the core 308 diameter and numerical aperture selection. The dispersion characteristics of the optical fiber 306 affect pulse broadening and spectral separation of the transmitted optical signal. The dispersion-compensated optical signal exits the optical fiber 306 at the output end 312 with controlled phase and intensity distribution. The optical fiber 306 is integrated with optical components that further analyze or detect the transmitted optical signal. The dispersion control within the optical fiber 306 is dependent on fiber design, length, and wavelength-specific refractive index properties.

In an embodiment, the system 300 further comprises an interface 314 disposed between the coupling element 304 and the input end 310, wherein the interface 314 reduces optical loss. The interface 314 (interchangeably referred as optical interface 314) provides an optical transition between the coupling element 304 and the input end 310 of the optical fiber 306, facilitating efficient signal transfer. The interface 314 comprises a material or feature that minimizes optical losses by refractive index matching or anti-reflective coatings. The optical interface 314 reduces Fresnel reflections that occur at abrupt refractive index changes between optical components. The interface 314 improves optical signal transmission efficiency by mitigating optical loss mechanisms. The interface 314 material comprises transparent polymers, optical adhesives, or thin-film coatings that reduce surface reflections. The interface 314 properties influence optical power coupling between the coupling element 304 and the optical fiber 306, improving signal transfer efficiency. The interface 314 alignment and positioning affect optical signal continuity and minimize transmission losses. The optical interface 314 comprises gradient index structures, surface roughness modifications, or refractive index-matching layers to optimize optical energy transfer. The optical interface 314 is influenced by mechanical alignment tolerances and refractive index properties. The optical characteristics of the interface 314 maintain signal integrity while preventing unwanted reflection artifacts. The interface 314 provides an optical transition that supports consistent signal propagation without significant degradation. The interface 314 is formed using bonding techniques, optical adhesives, or precision alignment features that stabilize the optical connection.

In an embodiment, the system 300 further comprises a detector 316 disposed at the output end 312 of the optical fiber 306, wherein the detector 316 receives the dispersion-compensated optical signal. The detector 316 is positioned to capture the optical signal exiting from the output end 312 of the optical fiber 306. The detector 316 comprises a light-sensitive element that interacts with the dispersion-compensated optical signal to generate a measurable response. The detector 316 is selected based on the wavelength, intensity, and modulation characteristics of the received dispersion-compensated optical signal. The detector 316 comprises one or more photodetection components such as photodiodes, avalanche photodetectors, or charge-coupled device arrays that convert the optical energy into an electrical signal. The sensitivity and response time of the detector 316 influence the accuracy of signal quality measurement. The detector 316 may incorporate a signal processing unit that amplifies, filters, or digitizes the detected signal for further analysis. The detector 316 operates within a predefined spectral range that matches the emission wavelength of the micro-LED source 302 and the transmission characteristics of the optical fiber 306. The positioning of the detector 316 relative to the output end 312 of the optical fiber 306 influences the coupling efficiency and signal reception quality. The detector 316 may be configured to operate in a continuous or pulsed detection mode depending on the characteristics of the transmitted optical signal. The detector 316 comprises a photosensitive region that absorbs the received dispersion-compensated optical signal and converts the absorbed dispersion-compensated optical signal into an electrical response that is processed by associated circuitry. The response characteristics of the detector 316 depend on factors such as quantum efficiency, noise characteristics, and operating temperature. The detector 316 interacts with downstream signal processing elements to analyze data extracted from the received dispersion-compensated optical signal. The detector 316 may be shielded from ambient light sources to minimize interference and improve signal detection accuracy.

In an embodiment, the coupling element 304 may comprise a micro-lens assembly that modifies the predefined divergence angle of the emitted optical signal. The micro-lens assembly comprises one or more refractive or diffractive optical components positioned in proximity to the emission aperture of the micro-LED source. The optical characteristics of the micro-lens assembly depend on focal length, curvature, numerical aperture, and material composition. The micro-lens assembly converges, collimates, or diverges the emitted optical signal based on the required propagation characteristics. The micro-lens assembly is fabricated using optical-grade glass, polymers, with well-defined refractive index properties. The micro-lens assembly interacts with the emitted optical signal by controlling phase front curvature, optical path length, and intensity distribution. The placement of the micro-lens assembly relative to the emission aperture influences beam shaping and coupling efficiency. The integration of the micro-lens assembly with the coupling element 304 modifies optical field distribution and enhances power transfer efficiency into the optical fiber 306. The micro-lens assembly may comprise an array of lenses to be able to increase the coupling efficiency of individual LEDs placed in an array to the corresponding individual fibers placed in a bundle. The micro-lens assembly is positioned using alignment techniques that optimize optical signal propagation and reduce divergence-related losses. The micro-lens assembly interacts with subsequent optical components to maintain a controlled optical signal profile for efficient transmission through the optical fiber 306.

In an embodiment, the coupling element 304 may comprise a diffractive optical unit that modifies at least one phase characteristic of the emitted optical signal. The diffractive optical unit comprises an optical structure that interacts with the wavefront of the optical signal to introduce controlled phase modifications. The diffractive optical unit consists of patterned micro-structures, phase gratings, or holographic optical elements that redistribute the optical field. The diffractive optical unit is fabricated using lithographic etching, laser ablation, or nano-imprinting methods that define high-resolution optical patterns. The material composition of the diffractive optical unit comprises transparent dielectric substrates, photopolymer layers, or semiconductor-based diffractive structures. The diffractive optical unit introduces constructive and destructive interference patterns that influence optical field propagation. The diffractive optical unit alters wavefront characteristics by introducing angular dispersion, phase modulation, or beam shaping effects. The spatial arrangement of the diffractive optical unit is determined based on the required beam transformation properties. The diffractive optical unit interacts with the emitted optical signal to control intensity distribution and spectral composition. The placement of the diffractive optical unit relative to the micro-LED source influences efficiency in modifying the phase characteristics of the emitted optical signal. The diffractive optical unit reduces unwanted diffraction artifacts while maintaining optical signal coherence for efficient coupling into the optical fiber 306. The interaction between the diffractive optical unit and the emitted optical signal influences propagation efficiency by modifying wavefront curvature and mode coupling conditions.

In an embodiment, the core 308 of the optical fiber 306 may be associated with a graded-index profile that regulates a modal dispersion of the dispersion-compensated optical signal. The graded-index profile comprises a refractive index variation across the radial direction of the core 308, reducing intermodal dispersion and improving optical signal propagation. The refractive index profile of the core 308 follows a continuous gradient, allowing optical modes to travel at varying speeds to compensate for dispersion effects. The graded-index profile is engineered to maintain optical signal integrity over short-to-medium transmission distances by minimizing pulse broadening. The core 308 is fabricated using a material with a controlled refractive index variation, including doped silica, fluorinated polymers, or specialty optical materials with graded refractive index characteristics. The graded-index profile influences optical mode propagation by reducing differential modal delays, enabling efficient signal transmission. The optical fiber 306 with a graded-index core 308 supports multiple optical modes, wherein the refractive index variation reduces intermodal interference. The graded-index profile minimizes the spread of optical pulses, allowing higher data rates and reduced signal distortion. The manufacturing process of the graded-index core 308 involves deposition techniques that create a controlled refractive index gradient during fiber fabrication. The graded-index profile modifies light propagation by continuously bending optical rays towards the central axis, minimizing modal dispersion. The graded-index core 308 enables efficient coupling with the coupling element 304 by optimizing optical mode overlap.

In an embodiment, the core 308 of the optical fiber 306 may be fabricated from a material selected from a fluorinated polymer, polymethyl methacrylate (PMMA), or silica-based glass to reduce chromatic dispersion of the dispersion-compensated optical signal. The selection of said material influences the refractive index properties of the core 308, minimizing wavelength-dependent dispersion effects. A fluorinated polymer exhibits a low refractive index and controlled dispersion characteristics, allowing chromatic dispersion reduction over the transmission length of the optical fiber 306. The material absorption and environmental stability of the fluorinated polymer facilitate signal propagation with reduced transmission losses, making said material suitable for short-to-medium optical links. Polymethyl methacrylate (PMMA), a polymer featuring optical transparency and a balanced refractive index profile, allows chromatic dispersion reduction while maintaining optical signal integrity. PMMA-based optical fibers exhibit flexibility, ease of fabrication, and mechanical durability, making said fibers applicable for data transmission applications. Silica-based glass, characterized by optical clarity and low dispersion coefficient, maintains refractive index properties over a broad wavelength range. Controlled dopant concentration in silica-based fibers allows dispersion management, facilitating optical transmission across various operational wavelengths. The fabrication of the core 308 may involve chemical vapor deposition, extrusion, or doping processes, providing dispersion control without excessive signal attenuation. The material composition of the core 308 influences spectral broadening and wavelength-dependent propagation delays, maintaining optical signal quality during transmission. The material properties of the core 308 contribute to chromatic dispersion compensation, allowing compatibility with short-distance optical communication systems.

In an embodiment, the interface 314 may comprise a refractive index-matching material layer disposed between the coupling element 304 and the input end 310 of the optical fiber 306. The refractive index-matching material layer minimizes optical reflection losses at the interface 314. The refractive index-matching material layer comprises an optically transparent adhesive, polymer film, or thin-film coating that adjusts the refractive index transition between the coupling element 304 and the input end 310. The refractive index-matching material layer reduces Fresnel reflections that occur at abrupt refractive index changes between the coupling element 304 and the optical fiber 306. The optical characteristics of the refractive index-matching material layer are determined based on the refractive index values of the coupling element 304 and the core 308. The refractive index-matching material layer improves optical coupling efficiency by reducing back reflections and insertion loss. The deposition of the refractive index-matching material layer involves spin coating, vapor deposition, or adhesive bonding techniques that create a uniform optical transition. The refractive index-matching material layer provides structural adhesion between optical components while maintaining optical clarity. The material properties of the refractive index-matching material layer are selected to maintain stability under varying environmental conditions. The refractive index-matching material layer enhances transmission characteristics by reducing signal distortion at the coupling interface.

In an exemplary embodiment, the interface 314 may be omitted in certain scenarios where the optical signal strength is sufficient for short-range communication. Although the removal of the interface 314 may increase optical losses, the optical link remains functional under conditions where the numerical aperture (NA) of the optical fiber 306 is large, resulting in high coupling efficiency, and the link length is short, thereby minimizing chromatic dispersion. The omission of the interface 314 can also contribute to a reduction in assembly costs by eliminating the need for a refractive index-matching material layer. In such cases, the coupling element 304 directly interfaces with the input end 310 of the optical fiber 306, relying on intrinsic optical properties to maintain adequate signal transmission.

In an embodiment, the detector 316 may comprise a light conversion unit disposed at the output end 312 of the optical fiber 306, wherein the light conversion unit converts the received dispersion-compensated optical signal into an electrical signal. The light conversion unit comprises one or more photodetection components that interact with the optical signal to generate a corresponding electrical output. The light conversion unit comprises semiconductor-based detection elements such as photodiodes, avalanche photodetectors, or charge-coupled device arrays that absorb incident photons and produce an electrical response. The selection of the light conversion unit depends on wavelength sensitivity, quantum efficiency, and response time. The material composition of the light conversion unit influences the absorption efficiency of the received optical signal. The light conversion unit may comprise an amplification circuit that processes the electrical output to improve signal-to-noise ratio. The output signal generated by the light conversion unit is used for downstream signal processing and data extraction. The positioning of the light conversion unit relative to the output end 312 of the optical fiber 306 influences optical coupling efficiency and detection accuracy. The interface between the optical fiber 306 and the light conversion unit comprises refractive index-matching layers to minimize optical reflection losses. The operating characteristics of the light conversion unit are influenced by external biasing conditions and environmental factors. The generated electrical signal undergoes conditioning and filtering to remove unwanted interference and improve signal clarity.

In an embodiment, the optical fiber 306 may comprise a predefined numerical aperture ranging from 0.17 to 0.7. The numerical aperture defines the acceptance angle for optical signal coupling into the optical fiber 306, influencing transmission efficiency and optical confinement. The optical fiber 306 exhibits multiple numerical aperture values within the specified range, including (0.17 to 0.25, 0.26 to 0.33, 0.34 to 0.45, 0.46 to 0.55, 0.56 to 0.7), wherein each numerical aperture value affects mode propagation characteristics and dispersion control. The material composition of the optical fiber 306 determines refractive index contrast between the core and cladding, affecting numerical aperture selection. The numerical aperture influences modal distribution and optical power coupling efficiency at the input end 310. A lower numerical aperture value such as 0.17 to 0.25 provides reduced modal dispersion, improving signal integrity over extended transmission distances. A higher numerical aperture value such as 0.56 to 0.7 increases optical confinement but introduces higher-order mode propagation, influencing dispersion properties. The refractive index gradient within the core 308 affects numerical aperture stability across different wavelengths. The numerical aperture selection is dependent on micro-LED source 302 emission characteristics and coupling element 304 beam-shaping properties. The optical fiber 306 numerical aperture variations allow flexibility in selecting appropriate optical parameters for specific transmission conditions. The numerical aperture defines angular acceptance for optical signal propagation, affecting overall transmission characteristics.

In an embodiment, the optical fiber 306 may be separated from the micro-LED source 302 by a first distance and is separated from the coupling element 304 by a second distance. The first distance determines the spatial relationship between the emission aperture of the micro-LED source 302 and the optical fiber 306 input end 310, affecting coupling efficiency. The second distance defines the positioning of the coupling element 304 relative to the optical fiber 306, influencing divergence correction and beam alignment. The separation distances are influenced by optical alignment tolerances, refractive index matching, and structural mounting constraints. The positioning of the optical fiber 306 relative to the micro-LED source 302 influences optical power coupling efficiency and minimizes signal divergence losses. The first distance and the second distance are selected based on the beam shaping strength of coupling element 304 and the numerical aperture of the optical fiber 306. The separation distances affect mode stability, transmission efficiency, and alignment sensitivity. The optical fiber 306 positioning is aligned based on optical system requirements and operational conditions. The first distance influences the angular acceptance of the optical signal at the input end 310, affecting overall transmission characteristics. The second distance determines the degree of divergence modification applied by the coupling element 304, regulating beam shaping properties. The separation distances are adjusted based on structural mounting constraints and optical alignment precision.

In an embodiment, a positioning assembly may control the first distance and the second distance to regulate optical power coupling efficiency between the optical fiber 306 and the micro-LED source 302. The positioning assembly comprises mechanical or electromechanical components that adjust the spatial alignment of the optical fiber 306 relative to the micro-LED source 302 and the coupling element 304. The positioning assembly comprises translation stages, adjustable mounts, or micro-actuators that provide precise displacement control. The positioning assembly maintains stable optical alignment while compensating for variations in coupling conditions. The positioning assembly supports multiple adjustment mechanisms, including manual, automated, or feedback-controlled positioning. The positioning assembly incorporates calibration features that facilitate precise alignment within predefined tolerances. The positioning assembly interfaces with the optical fiber 306 mounting structure to regulate angular and axial positioning. The positioning assembly comprises alignment reference markers or optical feedback elements that optimize coupling conditions. The positioning assembly supports active or passive alignment techniques to maintain optical transmission stability. The positioning assembly accommodates adjustments within predefined displacement ranges, allowing axial and angular corrections as required. The positioning assembly contributes to minimizing optical insertion losses while optimizing optical power transfer between components.

In an embodiment, the core 308 may comprise a photonic crystal structure to modify chromatic dispersion properties at an operational wavelength. The photonic crystal structure comprises a periodic arrangement of dielectric materials that influence light propagation by creating photonic bandgaps. The structural parameters of the photonic crystal, including periodicity, lattice geometry, and refractive index contrast, determine chromatic dispersion behavior. The photonic crystal structure is fabricated using lithographic patterning, self-assembly, or direct laser writing techniques to define periodic nanoscale features. The refractive index contrast between adjacent materials within the photonic crystal core 308 influences dispersion compensation and waveguide confinement properties. The photonic crystal structure modifies optical mode propagation by selectively altering group velocity dispersion characteristics at the operational wavelength. The interaction between the dispersion-compensated optical signal and the photonic crystal structure depends on the spatial distribution of dielectric features. The core 308 integrates photonic crystal properties to control dispersion effects across specific wavelength ranges, including visible, near infrared, and mid-infrared spectral regions. The fabrication of the photonic crystal structure involves depositing alternating high and low refractive index materials in periodic arrangements to achieve dispersion control. The photonic crystal structure is integrated with the optical fiber 306 to customize chromatic dispersion properties while maintaining efficient optical transmission. The periodic nature of the photonic crystal structure enables dynamic dispersion tuning based on structural modifications. The core 308 incorporating the photonic crystal structure compensates for wavelength-dependent dispersion effects, improving signal propagation stability.

In an embodiment, the detector 316 may be configured with an adaptive noise filter that filters unwanted optical interference in the dispersion-compensated optical signal. The adaptive noise filter dynamically adjusts filtering parameters based on detected signal fluctuations to improve signal quality. The adaptive noise filter comprises electronic or optical filtering elements that suppress unwanted noise contributions from ambient light, system reflections, or thermal fluctuations. The adaptive noise filter applies signal processing techniques, including bandpass filtering, wavelet transforms, or adaptive thresholding, to selectively filter interference. The detector 316 integrates the adaptive noise filter to distinguish relevant optical signal components from background noise. The filtering characteristics of the adaptive noise filter adjust based on the optical power levels, wavelength variations, and temporal fluctuations of the received dispersion-compensated optical signal. The adaptive noise filter is implemented using analog or digital signal processing techniques to remove spurious signal components while maintaining signal integrity. The adaptive noise filter operates within the detector 316 at predefined bandwidths based on optical transmission parameters. The adaptive noise filter reduces noise artifacts introduced by environmental factors, power supply fluctuations, or optical reflections. The adaptive noise filter dynamically updates filtering coefficients in real time to maintain a stable detection response. The adaptive noise filter integrates within the detection circuitry to improve signal-to-noise ratio and optical signal clarity.

In an embodiment, the micro-LED source 302 may emit an optical signal with a wavelength ranging from 400 nm to 3000 nm. The emission wavelength range comprises visible, near infrared, and mid-infrared spectral bands, covering multiple optical communication and sensing applications. The micro-LED source 302 emits optical signals at specific wavelength intervals, including 400 nm to 700 nm for visible light applications, 700 nm to 1400 nm for near-infrared applications, and 1400 nm to 3000 nm for mid-infrared applications. The emission wavelength is determined by semiconductor bandgap properties, doping concentration, and quantum well thickness. The micro-LED source 302 operates within a defined wavelength range to optimize spectral efficiency for optical fiber coupling. The micro-LED source 302 emits narrowband or broadband optical signals depending on active material composition and cavity design. The micro-LED source 302 wavelength tuning is achieved using temperature control, strain engineering, or external resonator feedback. The emission wavelength range allows compatibility with multiple optical fiber types, including silica-based and fluoride-based optical fibers. The micro-LED source 302 may comprise additional wavelength stabilization mechanisms to maintain spectral accuracy under variable operating conditions. The micro-LED source 302 supports wavelength-dependent modulation schemes for data encoding and optical transmission. The micro-LED source 302 is fabricated using epitaxial growth techniques that define semiconductor layer structures with wavelength-specific emission properties. The wavelength selection of the micro-LED source 302 is optimized for efficient power coupling into the optical fiber 306.

In an embodiment, the micro-LED source 302 may comprise a diameter ranging from 1 μm to 300 μm. The diameter of the micro-LED source 302 influences optical power output, beam divergence, and coupling efficiency with optical transmission components. The micro-LED source 302 is fabricated with diameter variations between 1 μm to 50 μm for high-density micro-display applications, 5 μm to 150 μm for optical interconnects, and 150 μm to 300 μm for high-power illumination and sensing applications. The diameter of the micro-LED source 302 determines optical emission area and photon extraction efficiency. The micro-LED source 302 size selection affects current injection uniformity, heat dissipation, and spectral stability. The micro-LED source 302 diameter is defined using photolithographic patterning, etching, or laser processing techniques that shape emission aperture geometry. The micro-LED source 302 operates with varying drive current densities based on active emission area and semiconductor material properties. The micro-LED source 302 with a smaller diameter exhibits higher modulation bandwidth, while a larger diameter supports higher optical power output. The micro-LED source 302 diameter influences emission divergence characteristics, affecting coupling performance with lenses, fibers, or waveguides. The micro-LED source 302 fabrication involves precision alignment to maintain structural integrity across different diameter configurations. The micro-LED source 302 emission uniformity is influenced by semiconductor doping distribution and active layer thickness. The micro-LED source 302 diameter selection is based on application-specific optical performance requirements, including beam shaping, spectral stability, and power distribution.

In an embodiment, the detector 316 may comprise a cascaded optical delay line unit that temporally separates spectral components of the dispersion-compensated optical signal for improved data recovery. The cascaded optical delay line unit comprises a sequence of optical delay elements that introduce controlled time delays for different spectral components. The delay elements consist of optical fiber segments, free-space propagation paths, or integrated photonic waveguides that introduce variable optical path lengths. The temporal separation achieved by the cascaded optical delay line unit enhances spectral resolution and enables more effective signal processing. The delay intervals are selected based on the dispersion properties of the transmitted optical signal and the operational wavelength range. The cascaded optical delay line unit is positioned within the detector 316 to interact with the dispersion-compensated optical signal before signal processing. The cascaded structure allows adjustable time delays for selective wavelength components, mitigating spectral overlap. The optical delay elements are fabricated using materials with controlled refractive index properties to maintain stable transmission characteristics. The cascaded optical delay line unit may incorporate phase-tunable elements that dynamically adjust delay intervals for adaptive signal correction. The optical delay elements are interconnected in a sequential arrangement to establish a progressive time delay across multiple spectral bands. The separation of spectral components reduces inter-symbol interference and facilitates more accurate data reconstruction. The cascaded optical delay line unit is integrated with optical filtering or detection components to analyze temporally separated spectral segments.

In an embodiment, the diameter of the core 308 of the optical fiber 306 may be adjusted within a range of 2 μm to 400 μm. The selection of core 308 diameter influences mode propagation characteristics, numerical aperture, and optical power confinement. The adjustment of core 308 diameter within the specified range determines optical signal transmission properties based on the application requirements. The core 308 diameter is varied within multiple sub-ranges including 2 μm to 10 μm, 10 μm to 50 μm, 50 μm to 150 μm, and 150 μm to 400 μm. The sub-range selection is based on modal propagation conditions and coupling efficiency requirements. A core 308 diameter within the 2 μm to 10 μm range supports single-mode propagation with minimal modal dispersion. A core 308 diameter within the 10 μm to 50 μm range allows low-order multimode propagation while maintaining limited intermodal interference. A core 308 diameter within the 50 μm to 150 μm range supports higher-order multimode transmission with increased optical power handling capacity. A core 308 diameter within the 150 μm to 400 μm range enables broad-area multimode propagation with relaxed alignment tolerances. The core 308 diameter variation is controlled through fiber fabrication processes such as preform extrusion, vapor deposition, or precision drawing techniques. The selected core 308 diameter influences optical confinement, dispersion characteristics, and transmission loss properties. The diameter selection is optimized for numerical aperture matching with optical coupling elements to improve optical power efficiency. The core 308 diameter variation supports application-specific transmission conditions for visible, near-infrared, and mid-infrared optical communication.

In an embodiment, multiple small-core optical fibers, each having a core diameter within the range of 2 μm to 10 μm, can be employed for optical signal transmission from a single micro-LED source. This configuration enables efficient optical power transfer while maintaining spatial coherence, similar to high-resolution imaging fiber bundles used in communication applications. For example, a high-resolution fiber array with core sizes below 10 μm and approximately 13,000 cores over a 2 mm area can be used for signal transfer applications. The use of multiple small-core fibers enhances optical coupling efficiency and mitigates signal delivery constraints associated with single-mode fibers, facilitating robust signal propagation for high-intensity optical sources such as micro-LEDs.

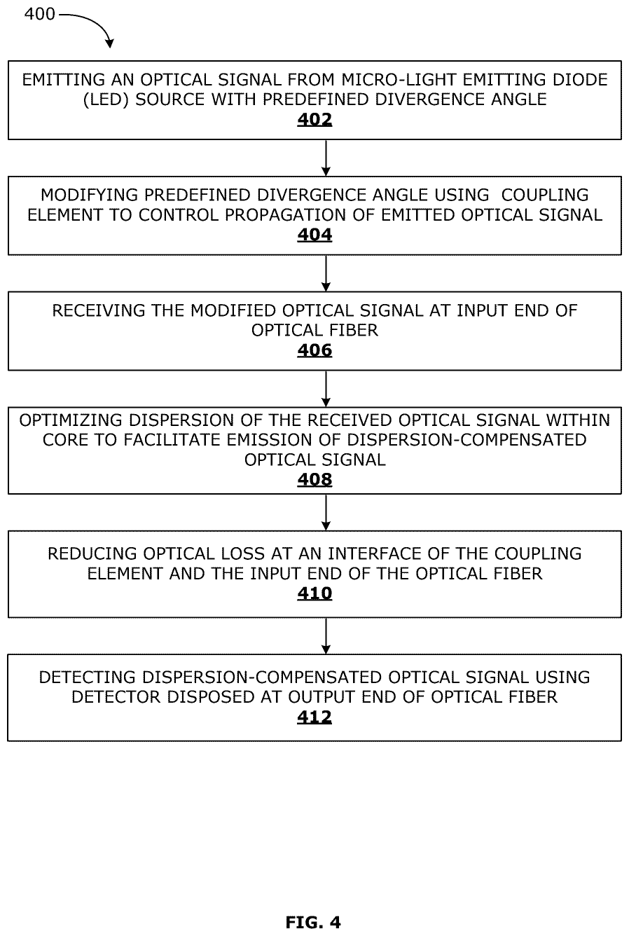

FIG. 4 illustrates a method 400 for optimizing propagation and dispersion of an optical signal in accordance with embodiments of the present disclosure. At step 402, an optical signal is emitted from a micro-LED source 302 with a predefined divergence angle. The micro-LED source 302 generates optical radiation through electroluminescence when an electrical current is applied. The emitted optical signal has a divergence angle determined by the structure of the micro-LED source 302, including the emission aperture, refractive index contrast, and semiconductor material composition. The predefined divergence angle influences the spatial distribution of the emitted optical signal and affects coupling efficiency with downstream optical components. The emission characteristics are dependent on the operating conditions of the micro-LED source 302, including drive current, junction temperature, and optical cavity structure. The emitted optical signal propagates outward from the micro-LED source 302 with an angular spread defined by optical design parameters. The emission wavelength and power intensity of the optical signal are controlled based on material selection and electrical input conditions.

At step 404, the predefined divergence angle of the emitted optical signal is modified using a coupling element 304 to control propagation of the optical signal. The coupling element 304 interacts with the emitted optical signal to reshape, redirect, or refocus its propagation path. The coupling element 304 comprises optical components such as micro-lenses, diffractive optical structures, or reflective surfaces that adjust the divergence angle of the optical signal. The positioning and optical properties of the coupling element 304 influence how the optical signal is transformed before entering the optical fiber 306. The modification of the predefined divergence angle is achieved by refractive, diffractive, or reflective interactions that alter the angular spread and intensity distribution of the optical signal. The coupling element 304 makes sure that the optical signal is directed toward the optical fiber 306 with controlled divergence to enhance transmission efficiency.

At step 406, the modified optical signal is received at an input end 310 of an optical fiber 306, wherein a core 308 of the optical fiber 306 has a predefined numerical aperture and a diameter. The optical fiber 306 serves as a transmission medium that guides the modified optical signal along a controlled path. The input end 310 of the optical fiber 306 is positioned to receive the optical signal from the coupling element 304 with minimal optical losses. The core 308 is structured to provide optical confinement and maintain signal integrity throughout transmission. The numerical aperture of the core 308 defines the acceptance angle of the optical fiber 306, influencing coupling efficiency. The diameter of the core 308 affects mode propagation characteristics, determining whether the optical fiber 306 supports single-mode or multimode transmission. The optical fiber 306 material composition, refractive index contrast, and structural geometry influence the efficiency of optical signal guidance. The received optical signal propagates through the core 308, undergoing dispersion effects that influence its transmission properties.

At step 408, dispersion of the received optical signal is minimized within the core 308 to facilitate the emission of a dispersion-compensated optical signal at an output end 312 of the optical fiber 306. The dispersion properties of the optical fiber 306 influence signal transmission characteristics, including pulse broadening, spectral spreading, and phase delay variations. The core 308 is having with dispersion-compensating properties to regulate modal dispersion and chromatic dispersion effects. The optimization of dispersion is achieved through material composition, refractive index profiling, and structural design of the optical fiber 306. The graded-index profile, doping concentration, and fiber length influence the dispersion properties of the core 308. The dispersion-compensated optical signal emerging from the output end 312 of the optical fiber 306 exhibits controlled phase and intensity characteristics.

At step 410, reducing optical loss at an interface 314 between the coupling element 304 and the input end 310. The interface 314 minimizes Fresnel reflections and optical losses during signal transfer. The interface 314 comprises a refractive index-matching material layer or anti-reflective coating that smooths the optical transition between the coupling element 304 and the input end 310. The reduction of optical reflection enhances transmission efficiency by minimizing back reflections that could interfere with signal propagation. The interface 314 is fabricated using optically transparent materials with refractive index properties to match the optical components. The interface 314 maintains optical signal continuity by reducing discontinuities in refractive index variations.

At step 412, the dispersion-compensated optical signal is detected using a detector 316 disposed at the output end 312 of the optical fiber 306. The detector 316 receives the dispersion-compensated optical signal and converts the received dispersion-compensated optical signal into an electrical or optical output for further analysis. The detector 316 comprises a photosensitive element that interacts with the received optical signal to generate a measurable response. The detector 316 comprises photodetection components such as photodiodes, avalanche photodetectors, or charge-coupled device arrays that process the received optical signal. The spectral sensitivity, quantum efficiency, and response time of the detector 316 influence signal measurement accuracy. The detector 316 is positioned at the output end 312 of the optical fiber 306 to receive the transmitted optical signal with minimal losses. The detector 316 extracts signal characteristics such as intensity, phase, and spectral distribution for further evaluation. The output response of the detector 316 is processed using signal analysis methods that quantify the quality of the dispersion-compensated optical signal.

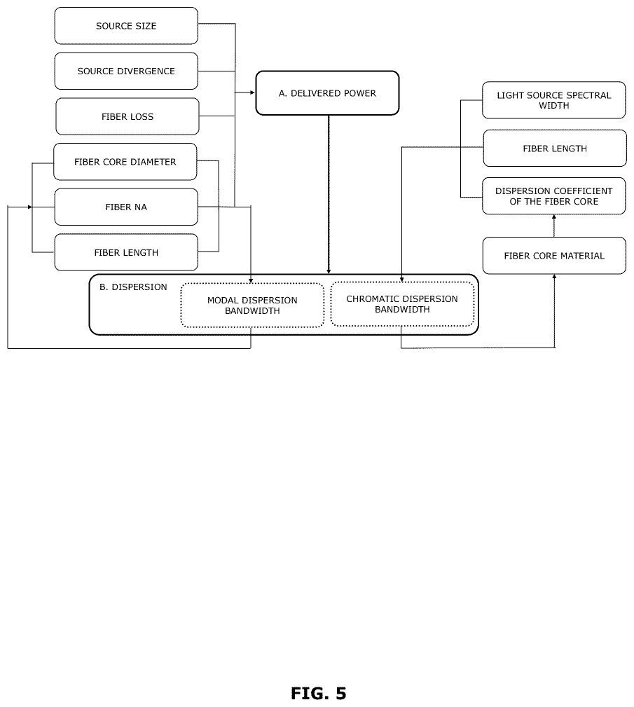

FIG. 5 illustrates a design chart for a short-distance micro-LED (similar to the micro-LED of FIG. 3), in accordance with embodiments of the present disclosure. Said design chart represents various parameters affecting optical signal transmission over short distances. The emission wavelength of the micro-LED influences the efficiency of light coupling into the optical fiber (similar to the optical fiber 306 of FIG. 3). The selection of micro-LED materials affects emission properties, optical power output, and spectral characteristics. The positioning of the micro-LED relative to the optical fiber determines the coupling efficiency, where misalignment may result in signal loss. The diameter of the optical fiber core and the numerical aperture impact the amount of light captured and transmitted. The refractive index contrast between the core and cladding of the fiber affects modal dispersion and transmission distance. The micro-LED array pitch and spacing influence the uniformity of optical power distribution. The inclusion of micro-optics, such as micro-lenses or collimators, modifies beam divergence and improves light coupling. The interconnect distance between the micro-LED and detector defines the overall transmission length and signal integrity. The use of refractive index matching materials or coatings can reduce reflection losses and improve transmission characteristics.

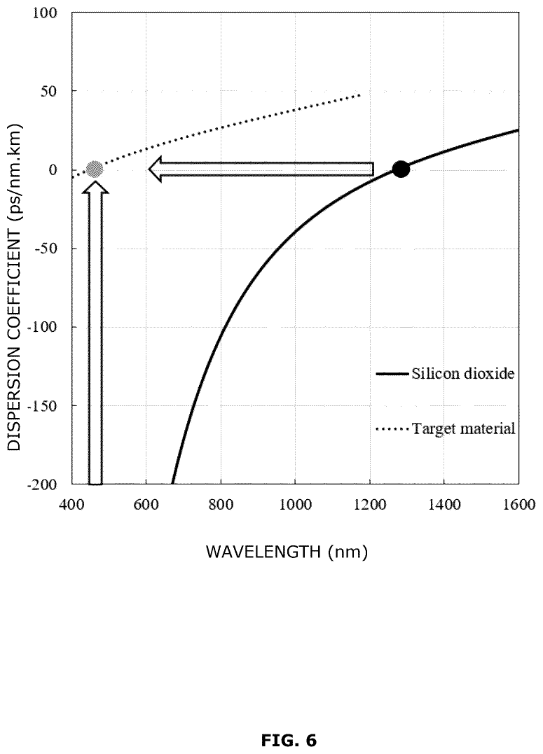

FIG. 6 illustrates a graphical representation of minimizing the chromatic dispersion coefficient for a short-distance link operating at 450 nm wavelength, ranging from 1m to 10m operating in a visible wavelength, in accordance with embodiments of the present disclosure. The dispersion coefficient is plotted against the operational wavelength, showing variations in dispersion across the visible spectrum. The graph indicates an optimal wavelength range where dispersion is minimized for 450 nm as an example, reducing signal distortion over short distances. The idea can be expanded to the other micro-LED based links operating at different wavelengths. The selection of fiber core material and refractive index influences dispersion characteristics. The numerical aperture, core diameter, and fiber length contribute to dispersion properties. The data provides insight into optimizing fiber parameters for short-distance optical communication.

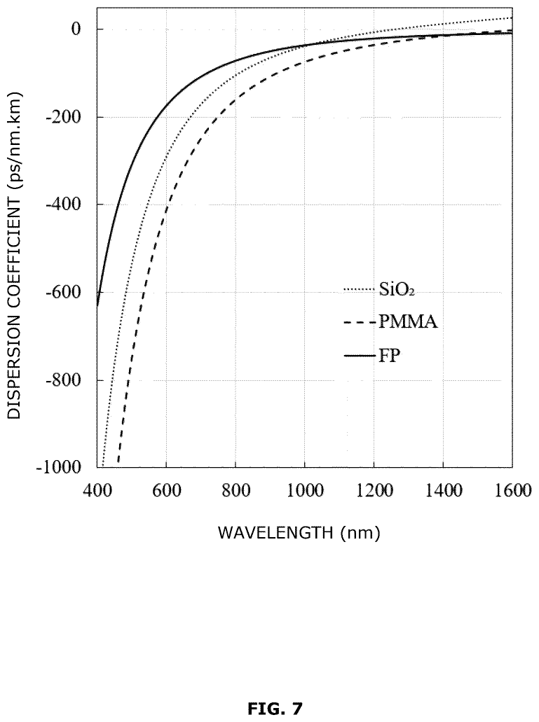

FIG. 7 illustrates a comparison between the dispersion coefficient of silicon oxide, PMMA, and a fluorinated polymer over a wavelength range of 400 to 1600 nm, in accordance with embodiments of the present disclosure. The dispersion coefficient varies across different wavelengths for each material, affecting signal propagation characteristics. Silicon oxide exhibits higher dispersion in shorter wavelengths, while PMMA and fluorinated polymers demonstrate lower dispersion over specific ranges. The refractive index contrast between core and cladding influences dispersion behavior. The selection of fiber material impacts chromatic dispersion, affecting optical signal transmission. The graphical data provides insights into material suitability for wavelength-dependent optical communication applications.

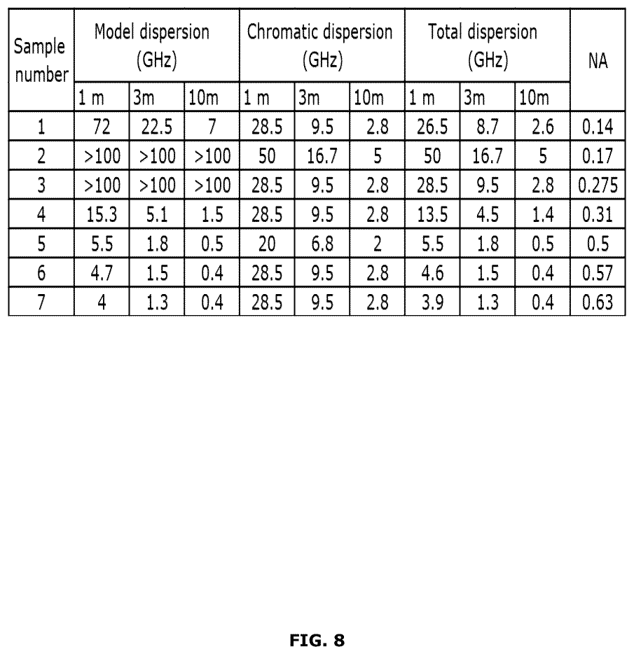

FIG. 8 shows a table of theoretical values for model dispersion, chromatic dispersion, and total dispersion for fiber lengths of 1 m, 3m, and 10m, calculated for various examples of fibers commercially available for imaging and communication applications. The table presents dispersion characteristics of different fiber materials across specific wavelength ranges. Model dispersion accounts for waveguide properties, while chromatic dispersion results from wavelength-dependent refractive index variations. Total dispersion combines both effects to determine signal transmission quality. The data provides a comparative analysis of commercially available fibers, aiding in material selection for short-distance optical communication and imaging applications requiring controlled dispersion properties.

In an embodiment, micro-LED source 302 emits an optical signal with a predefined divergence angle, allowing controlled optical signal propagation. The predefined divergence angle influences coupling efficiency with optical transmission components, minimizing signal loss and improving optical power transfer. The emission characteristics are adjusted based on drive current and wavelength selection, stabilizing optical signal integrity. The emitted optical signal undergoes controlled propagation, enabling minimal divergence-related dispersion before interacting with coupling element 304.

In an embodiment, coupling element 304 modifies the predefined divergence angle of the emitted optical signal, optimizing propagation efficiency. The modification of the divergence angle improves optical signal alignment with optical fiber 306, reducing insertion loss. The coupling element 304 redirects, reshapes, or collimates the optical signal, preventing excessive beam spread. The interaction between coupling element 304 and optical signal enhances transmission performance by maintaining a controlled angular profile.

In an embodiment, optical fiber 306 comprises core 308 with a predefined numerical aperture and diameter, assuring optimized dispersion characteristics. The numerical aperture defines the acceptance angle, improving optical signal confinement within core 308. The diameter of core 308 regulates modal propagation, reducing multimode interference. The controlled dispersion within core 308 prevents pulse broadening, stabilizing optical transmission over the fiber length. The output end 312 emits a dispersion-compensated optical signal with minimized phase distortion, improving signal fidelity.

In an embodiment, interface 314 reduces optical loss at the interface 314 disposed between the coupling element 304 and input end 310, enhancing optical signal transmission. The refractive index-matching properties of interface 314 minimize Fresnel reflection losses, improving optical power transfer. The interface 314 stabilizes optical coupling efficiency, reducing unwanted optical feedback. The optical signal undergoes minimal reflection-induced distortions, maintaining a high signal-to-noise ratio during transmission through optical fiber 306.

In an embodiment, detector 316 receives the dispersion-compensated optical signal at output end 312, detecting signal quality parameters. The detector 316 converts the received optical signal into an electrical response, allowing further signal analysis. The sensitivity of detector 316 determines measurement accuracy, stabilizing optical signal detection. The spectral response of detector 316 aligns with the emitted wavelength, minimizing noise artifacts. The detected signal is processed for quality evaluation, enabling optimal transmission performance.

In an embodiment, micro-lens assembly within coupling element 304 modifies the divergence angle of the emitted optical signal, enhancing beam collimation. The micro-lens assembly improves optical power density within the transmission path, minimizing beam spread. The collimated optical signal undergoes optimized fiber coupling, reducing insertion loss. The interaction between micro-lens assembly and emitted optical signal stabilizes angular distribution, increasing transmission efficiency.

In an embodiment, diffractive optical unit within coupling element 304 modifies at least one phase characteristic of the emitted optical signal, controlling beam shaping. The phase modification enhances optical wavefront alignment with optical fiber 306, reducing phase mismatches. The diffractive optical unit optimizes optical signal coherence, improving coupling efficiency. The wavefront manipulation reduces beam divergence, maintaining a controlled optical field distribution for stable fiber transmission.

In an embodiment, core 308 of optical fiber 306 comprises a graded-index profile that regulates modal dispersion, improving optical signal confinement. The graded-index profile minimizes intermodal dispersion by continuously adjusting refractive index variations. The controlled refractive index profile enhances transmission stability, reducing pulse broadening. The graded-index structure supports high-bandwidth optical transmission, stabilizing long-distance signal propagation.

In an embodiment, core 308 of optical fiber 306 fabricated from a fluorinated polymer provides a lower refractive index than conventional fiber materials, reducing chromatic dispersion by minimizing wavelength-dependent propagation delays. Said material selection decreases spectral broadening of the dispersion-compensated optical signal, improving transmission integrity over the length of optical fiber 306. Core 308 fabricated from polymethyl methacrylate (PMMA) provides optical transparency and a balanced refractive index profile, allowing control over chromatic dispersion. Said material selection reduces pulse broadening effects, stabilizing optical signal transmission within optical fiber 306. The mechanical flexibility of PMMA allows adaptation to various optical link configurations without compromising dispersion control. Core 308 fabricated from silica-based glass provides a controlled refractive index with low dispersion characteristics, maintaining signal stability across a wide wavelength range. The inclusion of dopants in silica-based glass allows dispersion management, minimizing wavelength-dependent signal distortion. Fabrication techniques such as chemical vapor deposition, extrusion, or doping define material properties of core 308, facilitating dispersion compensation without excessive signal attenuation. The interaction between core material and dispersion-compensated optical signal reduces chromatic distortion while preserving optical signal clarity.

In an embodiment, interface 314 comprises a refractive index-matching material layer, minimizing reflection losses at the interface 314 disposed between the coupling element 304 and input end 310. The refractive index-matching properties improve optical coupling efficiency, preventing back reflections. The interface 314 stabilizes optical signal transmission by reducing optical impedance mismatch. The optical transition layer assures high transmission fidelity, minimizing signal reflection artifacts.

In an embodiment, detector 316 comprises a light conversion unit that converts the received dispersion-compensated optical signal into an electrical signal, enabling real-time signal processing. The light conversion unit improves detection accuracy, minimizing noise artifacts. The photodetection efficiency stabilizes signal measurement, enabling reliable optical signal evaluation. The detector 316 interacts with signal processing components to extract optical data with minimal distortion.

In an embodiment, optical fiber 306 comprises a predefined numerical aperture ranging from 0.17 to 0.7, optimizing optical signal confinement. The numerical aperture selection regulates mode propagation efficiency, stabilizing optical power retention. The controlled numerical aperture reduces beam divergence, improving fiber coupling accuracy. The numerical aperture optimization balances transmission efficiency and dispersion control, maintaining stable optical propagation characteristics. The table. 1 represents the effect of different numerical aperture values on multiple optical performance parameters. Lower NA values provide stronger dispersion control, while higher NA values improve coupling efficiency and optical power retention.

TABLE 1

| Numerical | Optical | | Mode | |
|---|---|---|---|---|
| Aperture | Power | Coupling | Propagation | Dispersion |
| (NA) | Retention | Efficiency | Stability | Control |
| 0.17 | * | * | * | ***** |
| 0.3 | ** | ** | ** | **** |
| 0.45 | *** | *** | *** | *** |
| 0.6 | **** | **** | **** | ** |
| 0.7 | ***** | ***** | ***** | * |

In an embodiment, optical fiber 306 is separated from micro-LED source 302 by a first distance and separated from coupling element 304 by a second distance, optimizing optical alignment. The first and second distances regulate optical beam positioning, improving coupling efficiency. The distance adjustments minimize insertion loss, maintaining transmission stability. The optimized optical spacing reduces signal attenuation, stabilizing optical power transfer.

In an embodiment, positioning assembly regulates first and second distances between optical fiber 306, micro-LED source 302, and coupling element 304, optimizing optical power coupling efficiency. The positioning assembly allows fine-tuned optical alignment, reducing beam misalignment errors. The controlled positioning minimizes transmission loss, stabilizing optical signal propagation. The adjustable positioning improves optical mode overlaps, enhancing coupling performance.

In an embodiment, core 308 comprises a photonic crystal structure that modifies chromatic dispersion properties at an operational wavelength, stabilizing spectral transmission. The photonic crystal structure introduces wavelength-dependent refractive index variations, improving dispersion compensation. The periodic refractive index modulation regulates optical phase velocity, maintaining stable optical transmission. The structured photonic material reduces dispersion-induced signal broadening, stabilizing spectral integrity.

In an embodiment, detector 316 is configured with an adaptive noise filter that removes unwanted optical interference from the dispersion-compensated optical signal, improving signal accuracy. The adaptive noise filter dynamically suppresses noise fluctuations, stabilizing detection performance. The real-time noise filtering reduces signal distortions, enhancing optical measurement fidelity. The detector 316 interacts with noise suppression mechanisms to maintain high signal-to-noise ratio conditions.

In an embodiment, micro-LED source 302 comprises a diameter ranging from 1 μm to 300 μm, regulating optical beam divergence. The diameter selection influences emission power density, stabilizing optical coupling efficiency. The controlled diameter improves beam shaping characteristics, reducing optical mode mismatch. The emission profile minimizes beam divergence effects, maintaining stable optical propagation properties.

In an embodiment, the diameter of core 308 of optical fiber 306 is adjusted within a range of 2 μm to 400 μm, regulating optical mode propagation characteristics. A core 308 diameter within 2 μm to 10 μm supports single-mode transmission, minimizing intermodal dispersion and improving phase stability. A core 308 diameter within 10 μm to 50 μm allows low-order multimode propagation, balancing dispersion control and optical power handling. A core 308 diameter within 50 μm to 150 μm increases multimode transmission capacity while maintaining moderate dispersion effects. A core 308 diameter within 150 μm to 400 μm enables broad-area multimode propagation, improving optical power confinement but increasing modal dispersion. The selection of core 308 diameter optimizes coupling efficiency and optical signal confinement, based on application requirements. Table. 2 depicts that, core 308 diameter within 2 μm to 10 μm supports single-mode propagation, minimizing intermodal dispersion and assuring high transmission stability. A core 308 diameter within 10 μm to 50 μm enables low-order multimode propagation, balancing optical power transmission and dispersion control. A core 308 diameter within 50 μm to 150 μm increases multimode capacity while introducing moderate intermodal dispersion. A core 308 diameter within 150 μm to 400 μm facilitates broad-area multimode propagation, enhancing optical power transmission but increasing dispersion effects and reducing coupling efficiency. The selection of core 308 diameter influences optical confinement, signal integrity, and application-specific transmission performance.

TABLE 2

| Core | Mode | | Optical |
|---|---|---|---|
| Diameter | Propagation | Intermodal | Power |
| (μm) | Type | Dispersion | Transmission |
| 2 μm | Single-Mode | * | * |
| 10 μm | Single-Mode | * | ** |
| 50 μm | Low-Order | ** | *** |
| | Multimode | | |
| 150 μm | Multimode | *** | **** |
| 400 μm | Broad-Area | ***** | ***** |
| | Multimode | | |

In an embodiment, emitting an optical signal from micro-LED source 302 with a predefined divergence angle enables controlled propagation. Modifying the predefined divergence angle using coupling element 304 optimizes beam directionality for efficient coupling into optical fiber 306. Receiving the modified optical signal at input end 310 facilitates guided transmission through core 308, where dispersion is compensated to reduce chromatic and modal distortions. Reducing optical loss at the interface 314 between the coupling element 304 and input end 310, improves transmission efficiency.

1. A system to optimize propagation and dispersion of an optical signal, the system comprising:
a micro-light emitting diode (LED) source emits the optical signal with a predefined divergence angle;
a coupling element optically coupled to the micro-LED source, wherein the coupling element modifies the predefined divergence angle to control propagation of the emitted optical signal;
an optical fiber comprising a core having a predefined numerical aperture and a diameter, wherein the core receives the modified emitted optical signal at an input end, wherein the core minimizes dispersion of the received optical signal and facilitates emission of a dispersion-compensated optical signal at an output end;
an interface disposed between the coupling element and the input end, wherein the interface reduces optical loss at the junction; and
a detector disposed at the output end of the optical fiber, wherein the detector receives the dispersion-compensated optical signal.

2. The system of claim 1, wherein the coupling element comprises a diffractive optical unit configured to modify at least one phase characteristic of the emitted optical signal.

3. The system of claim 1, wherein the core is associated with a graded-index profile that regulates a modal dispersion of the dispersion-compensated optical signal.

4. The system of claim 1, wherein the core is fabricated from a material selected from fluorinated polymer, polymethyl methacrylate (PMMA), or silica-based glass to reduce chromatic dispersion of the dispersion-compensated optical signal.

5. The system of claim 1, wherein the interface comprises a refractive index-matching material layer disposed between the coupling element and the input end of the optical fiber.

6. The system of claim 1, wherein the detector comprises a light conversion unit disposed at the output end of the optical fiber, wherein the light conversion unit converts the received dispersion-compensated optical signal into an electrical signal.

7. The system of claim 1, wherein the optical fiber comprises a predefined numerical aperture ranging from 0.17 to 0.7.

8. The system of claim 1, wherein the optical fiber is separated from the micro-LED source by a first distance.

9. The system of claim 1, wherein the optical fiber is separated from the coupling element by a second distance.

10. The system of claim 9, further comprising a positioning assembly configured to control the first distance and the second distance to regulate an optical power coupling efficiency between the optical fiber and the micro-LED source.

11. The system of claim 1, wherein the core comprises a photonic crystal structure to modify chromatic dispersion properties at an operational wavelength.

12. The system of claim 1, wherein the detector is configured with an adaptive noise filter that filters unwanted optical interference in the dispersion-compensated optical signal.

13. The system of claim 1, wherein the micro-LED source emits an optical signal with a wavelength ranging from 400 nm to 3000 nm.

14. The system of claim 1, wherein the micro-LED source comprises a diameter ranging from 1 μm to 300 μm.

15. The system of claim 1, wherein the detector comprises a cascaded optical delay line unit configured to temporally separate the spectral components of the dispersion-compensated optical signal for improved data recovery.

16. The system of claim 1, wherein the diameter of the core of the optical fiber is adjusted within a range of 2 μm to 400 μm.

17. A method for optimizing propagation and dispersion of an optical signal, the method comprising:
emitting an optical signal from a micro-light emitting diode (LED) source with a predefined divergence angle;
modifying the predefined divergence angle using a coupling element to control propagation of the emitted optical signal;
receiving the modified optical signal at an input end of an optical fiber, wherein a core the optical fiber has a predefined numerical aperture and a diameter;
optimizing dispersion of the received optical signal within the core to facilitate the emission of a dispersion-compensated optical signal at an output end of the optical fiber;
reducing optical loss at an interface disposed between the coupling element and the input end; and
detecting the dispersion-compensated optical signal using a detector disposed at the output end of the optical fiber.
